(19) United States
(12) Patent Application Publication
(10) Pub. No.: US 2014/0251094 A1
(43) Pub. Date: Sep. 11, 2014

(54) AIR SUCTION SCREW TIGHTENING APPARATUS

(71) Applicant: Tera Autotech Corporation, Taichung City (TW)

(72) Inventors: Peng-Lai CHEN, TAICHUNG CITY (TW); YI-LUNG LEE, TAICHUNG CITY (TW); Chin-Sung LIN, TAICHUNG CITY (TW)

(73) Assignee: TERA AUTOTECH CORPORATION, TAICHUNG CITY (TW)

(21) Appl. No.: 13/793,422

(22) Filed: Mar. 11, 2013

(51) Int. Cl. B25B 23/08

(52) U.S. Cl. CPC B25B 23/08
USPC 81/430

(57) ABSTRACT

An air suction screw tightening apparatus to suck and fasten a screw comprises a power driver, a screwdriver fastened to the power driver, a holding assembly connected to the power driver and an air suction member. The screwdriver includes a screw tightening portion which has a contact end in contact with the screw for holding thereof. The holding assembly includes a housing case and a damping portion corresponding to the contact end. The damping portion and screw tightening portion form at least one gap between them to suck the screw.

Through providing the damping portion, shaking of the screwdriver during spinning can be reduced. Moreover, with cooperation of the gap and air suction member, the screw can be sucked and held.

### FIELD OF THE INVENTION

The present invention relates to a screw tightening apparatus and particularly to an air suction screw tightening apparatus.

### BACKGROUND OF THE INVENTION

Screw is one of most commonly used fastening elements in all types of apparatus. More precise objects often require more precise matching of screws and screw holes for fastening. During repairs and maintenance related apparatus or objects can be inspected by unfastening the screws. In automatic production processes, an automatic screw fastening mechanism often is used to tighten corresponding screws to increase production efficiency. For instance, U.S. publication No. 2012/0067176 entitled “Automatic screw tightening apparatus” discloses an automatic screw tightening mechanism to fasten a screw onto a screwdriver via air suction. It mainly relies on an air passage formed via a gap between the screwdriver and a screw holder to suck the screw onto the screwdriver to automatically tighten the screw.

But attaching the screw via the air suction to the screwdriver in the aforesaid structure cannot always guarantee that the screw and the screwdriver are connected in alignment. A slight slant could make tightening of the screw difficult and affect fastening result. Moreover, in the automatic screw tightening mechanisms for miniaturization (smaller than 2 mm), precision requirement is even more critical. A small screw tightening error could cause fastening failure. In addition, after the screw has been attached to the screwdriver, the screw would possibly be dropped during spinning of the screwdriver due to shaking, thus results in fastening failure and lower production efficiency. Since the aforesaid U.S. application relies on the gap between the screwdriver and screw holder to form the air passage for air suction, shaking of the screwdriver during spinning is unavoidable. Such a shaking problem cannot be tolerated in miniaturized screw fastening.

### SUMMARY OF THE INVENTION

The primary object of the present invention is to solve the problem of shaking in miniaturized screw fastening during spinning of the screwdriver because of the gap that results in dropping of the screw or unsecure screw fastening.

To achieve the foregoing object, the present invention provides an air suction screw tightening apparatus to suck a screw and perform fastening thereof. The air suction screw tightening apparatus comprises a power driver, a screwdriver fastened to the power driver, a holding assembly connected to the power driver and an air suction member. The power driver provides spinning power. The screwdriver includes a connecting section connected to the power driver, an extending section and a screw tightening portion at one end of the extending section remote from the connecting section. The screw tightening portion has a contact end remote from the extending section to contact the screw for holding thereof. The holding assembly includes a housing case to house the screwdriver, an air suction port formed on the housing case and a damping portion corresponding to the contact end. The damping portion has an opening run through by the screw tightening portion and at least one leaning section in contact with the screw tightening portion to prevent the screwdriver from shaking. The damping portion and screw tightening portion form at least one gap between them to communicate with the air suction port. The air suction member is connected to the air suction port to suck the screw through air via the air suction port and the gap to securely hold the screw at the contact end.

By means of the structure set forth above, the invention provides features as follow:

1. While the air suction member sucks the screw through the gap, the leaning section on the damping portion can reduce shaking of the screwdriver during spinning thereof.

2. It is suitable for automatic fastening of miniaturized screws without the concern of dropping of the screws from the contact end because of shaking, and the screws also can be precisely fastened at intended positions.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a sectional view of the invention.

FIG. 4A is a perspective view of the screwdriver according to the invention.

FIG. 4B is a fragmentary enlarged view according to FIG. 4A.

FIG. 5 is a schematic end view of the screwdriver and damping portion of a first embodiment of the invention.

FIG. 6 is a schematic end view of the screwdriver and damping portion of a second embodiment of the invention.

### DETAILED DESCRIPTION OF THE PREFERRED EMBODIMENTS

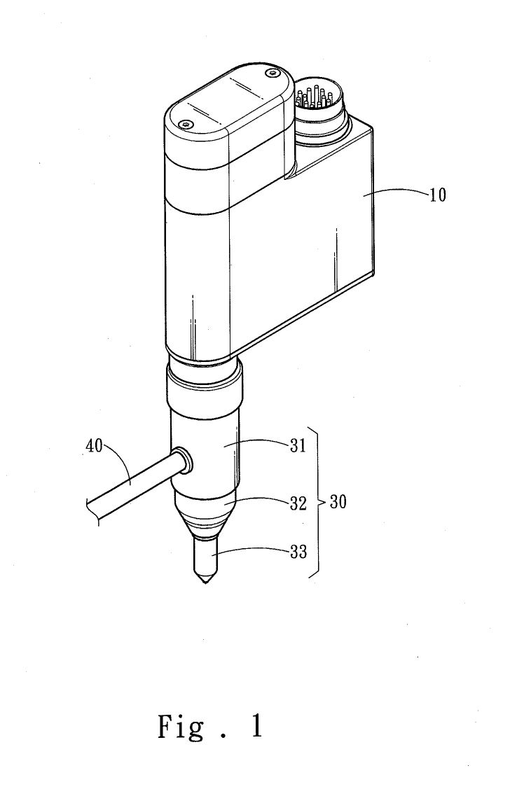

Please refer to FIGS. 1, 2 and 3, the present invention aims to provide an air suction screw tightening apparatus to suck a screw 50 for fastening. The apparatus comprises a power driver 10, a screwdriver 20 fastened to the power driver 10, a holding assembly 30 connected to the power driver 10 and an air suction member 40. The power driver 10 provides spinning power. The screwdriver 20 includes a connecting section 21 connected to the power driver 10, an extending section 22 and a screw tightening portion 23 at one end of the extending section 22 remote from the connecting section 21. The screw tightening portion 23 has a contact end 231 remote from the extending section 22 to contact the screw 50 for holding thereof. The holding assembly 30 includes a housing case 31 to house the screwdriver 20, an air suction port 311 formed on the housing case 31 and a damping portion 34 corresponding to the contact end 231. The damping portion 34 has an opening 341 run through by the screw tightening portion 23 and at least one leaning section 342 in contact with the screw tightening portion 23 to prevent the screwdriver 20 from shaking. The damping portion 34 and screw tightening portion 23 form at least one gap 60 between them to communicate with the air suction port 311. The air suction member 40 is connected to the air suction port 311 to suck the screw 50 via air suction through the air suction port 311 and the gap 60 to securely hold the screw 50 at the contact end 231.

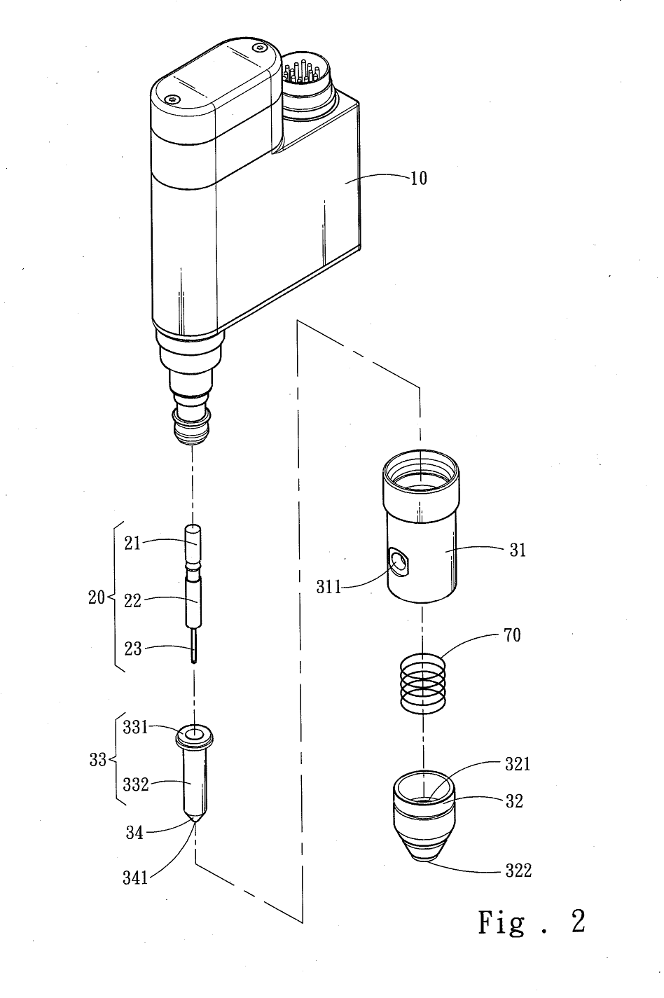

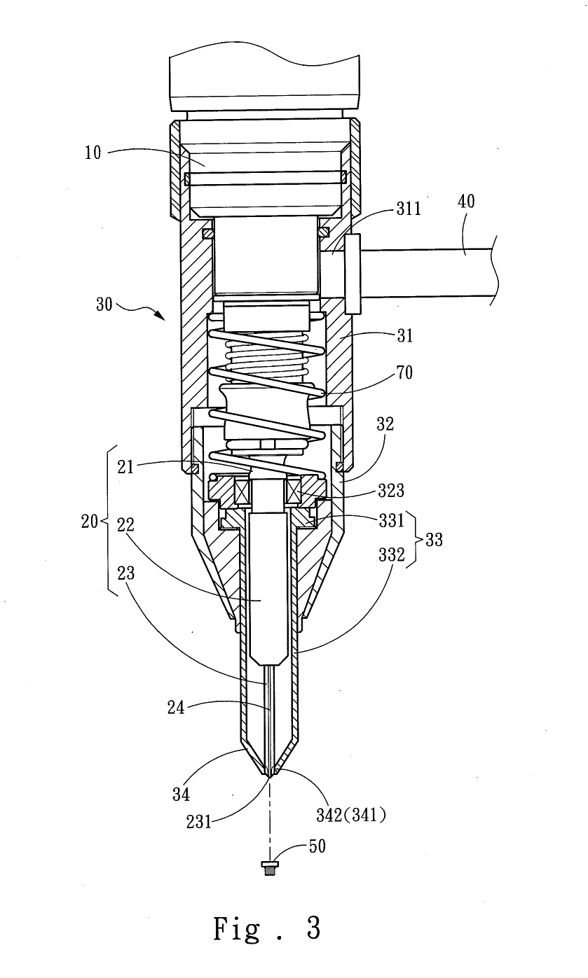

Please refer to FIGS. 2 and 3, more specifically, the holding assembly 30 further includes a coupling member 32 connected to one end of the housing case 31 remote from the power driver 10, and an extending holder 33 connecting to the coupling member 32. Since the screwdriver 20 has to be changed according to the size of the screw 50, a convenient detachable structure ought to be used to facilitate coupling and positioning. In this embodiment, the coupling member 32 and housing case 31 can be disassembled to change the screwdriver 20. During replacement of the screwdriver 20, the desired screwdriver 20 is placed in the extending holder 33 first, and then the extending holder 33 together with the screwdriver 20 are disposed in the coupling member 32 and coupled with the housing case 31 for holding. The coupling member 32 has a first leaning portion 321 and an aperture 322 at one end remote from housing case 31. The extending holder 33 has a second leaning portion 331 corresponding to and leaning on the first leaning portion 321 and a sleeve portion 332 running through the aperture 322. The sleeve portion 332 holds the extending section 22 and screw tightening portion 23 of the screwdriver 20. The damping portion 34 is located at one end of the sleeve portion 322 remote from the housing case 31. Thus, the extending holder 33 is securely connected to the housing case 31 through the coupling member 32, and the connecting section 21 is also connected to the power driver 10. On the other hand, through the damping portion 34 on the extending holder 33, the shaking problem of the screw tightening portion 23 during spinning of the screwdriver 20 can be reduced. In addition, the coupling member 32 further has an auxiliary holding bearing 323 coupled on the extending section 22. Through the auxiliary holding bearing 323, spinning friction can be reduced and stability of the screwdriver 20 during spinning also is enhanced. Moreover, the housing case 31 further can house an elastic element 70 which is butted between the housing case 31 and auxiliary holding bearing 323 to increase the buffer while the apparatus is in operation.

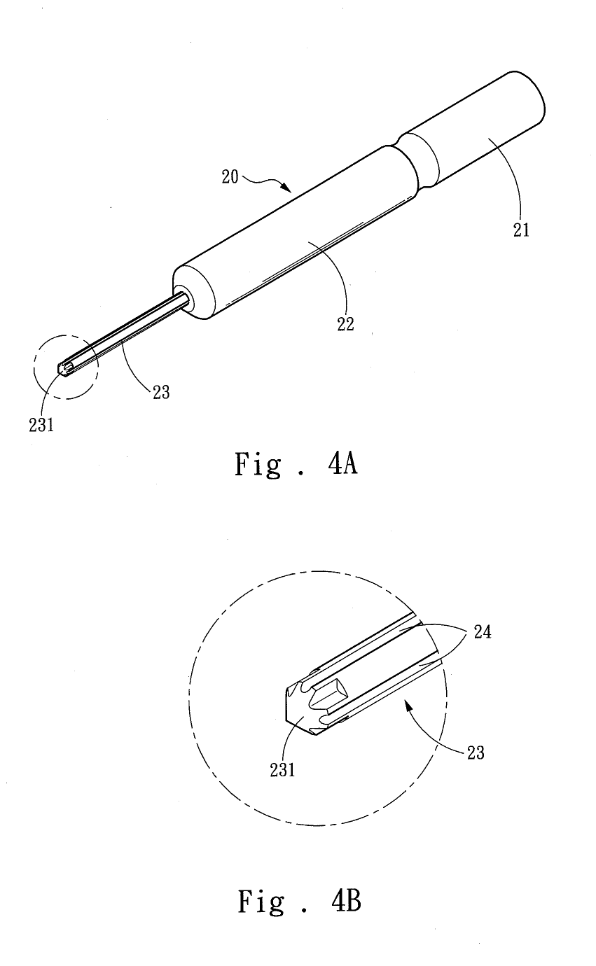

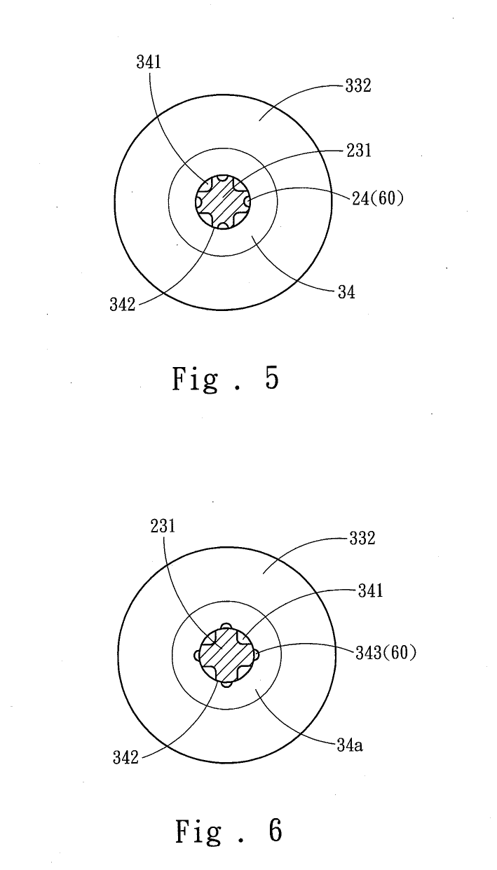

Please refer to FIGS. 4A and 4B, the contact end 231 of the screwdriver 20 is formed in a crisscross shape to contact the screw 50 for wrenching and tightening thereof. The screwdriver 20 also has a plurality of air flowing members 24 on the screw tightening portion 23. The air flowing members 24 are extended from the contact end 231 towards the connecting section 21. The screw tightening portion 23 forms grooves on the outer surface. Also referring to FIG. 5, the opening 341 is formed at a diameter the same as that of the screw tightening portion 23 so that the screw tightening portion 23 is in contact with the leaning section 342, and multiple gaps 60 are formed between the air flowing members 24 and leaning section 342. In this embodiment, the air flowing members 24 have four sets spaced from each other at 90 degrees about the center of the screwdriver 20. The gaps 60 communicate with the air suction port 311 (also referring to FIG. 3). Hence the air suction member 40 sucks the screw 50 via the air suction port 311 through the gaps 60. Such a structure can prevent shaking of the screwdriver 20 during spinning and also suck the screw 50 at the same time.

FIG. 6 illustrates another approach of forming the gaps 60. The damping portion 34a has a plurality of recesses 343 and a plurality of leaning sections 342 between the recesses 343. The recesses 343 and screw tightening portion 23 form multiple gaps 60 between them (referring to FIG. 4A). In this embodiment, the recesses 343 have four sets spaced from each other at 90 degrees about the center of the screwdriver 20. Such a structure does not need the air flowing members 24 on the screw tightening portion 23. By forming the recesses 343 on the damping portion 34a, the leaning sections 342 are in contact with the screw tightening portion 23, and the recesses 343 and the screw tightening portion 23 form a plurality of gaps 60 between them.

As a conclusion, the invention can provide features as follow:

1. While the air suction member sucks the screw through the gaps, the leaning section on the damping portion can reduce shaking of the screwdriver during spinning thereof.

2. It is suitable for automatic fastening of miniaturized screws without the concern of dropping of the screws from the contact end due to shaking, and the screws also can be precisely fastened at intended positions.

3. Through the air flowing members on the screw tightening portion or recesses on the damping portion, the gaps are formed, thus the design is simpler and fabrication is easier.

4. Through the design of the auxiliary holding bearing and leaning section, the extending section and screw tightening portion of the screwdriver can be held as desired to avoid excessive shaking of the screwdriver during spinning thereof that might otherwise affect fastening accuracy.

In short, the present invention provides significant improvements over the conventional techniques.

While the preferred embodiments of the invention have been set forth for the purpose of disclosure, they are not the limitation of the invention, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An air suction screw tightening apparatus to suck and fasten a screw, comprising:
a power driver to provide spinning power;
a screwdriver which is fastened to the power driver and includes a connecting section connected to the power driver, an extending section and a screw tightening portion at one end of the extending section remote from the connecting section, the screw tightening portion including a contact end remote from the extending section to contact the screw for holding thereof;
a holding assembly which is connected to the power driver and includes a housing case to house the screwdriver, an air suction port formed on the housing case and a damping portion corresponding to the contact end, the damping portion including an opening run through by the screw tightening portion and at least one leaning section in contact with the screw tightening portion to prevent shaking of the screwdriver, the damping portion and the screw tightening portion forming at least one gap between them to communicate with the air suction port; and
an air suction member connected to the air suction port to suck the screw through air via the air suction port and the gap to hold the screw at the contact end.

2. The air suction screw tightening apparatus of claim 1, wherein the screwdriver includes a plurality of air flowing members formed on the screw tightening portion to form multiple gaps with the leaning section between them.

3. The air suction screw tightening apparatus of claim 2, wherein the air flowing members include four sets spaced from each other at ninety degrees about a center of the screwdriver.

4. The air suction screw tightening apparatus of claim 1, wherein the damping portion includes a plurality of recesses and a plurality of leaning sections between the recesses, the recesses and the screw tightening portion forming a plurality of gaps between them.

5. The air suction screw tightening apparatus of claim 4, wherein the recesses include four sets spaced from each other at ninety degrees about a center of the screwdriver.

6. The air suction screw tightening apparatus of claim 1, wherein the holding assembly further includes a coupling member connected to one end of the housing case remote from the power driver to hold the screwdriver.

7. The air suction screw tightening apparatus of claim 6, wherein the coupling member further includes an auxiliary holding bearing coupled on the extending section of the screwdriver for holding thereof.

8. The air suction screw tightening apparatus of claim 6, wherein the holding assembly further includes an extending holder connected to the coupling member, the coupling member including a first leaning portion and an aperture at one end remote from the housing case, the extending holder including a second leaning portion corresponding to and leaning on the first leaning portion and a sleeve portion running through the aperture, the sleeve portion holding the extending section and the screw tightening portion of the screwdriver, the damping portion being located at one end of the sleeve portion remote from the housing case.
